(19) United States
(12) Patent Application Publication
(10) Pub. No.: US 2026/0064197 A1
(43) Pub. Date: Mar. 5, 2026

(54) EYE AND FACE TRACKING WITH UNDER DISPLAY CAMERA AND LED

(71) Applicant: Meta Platforms Technologies, LLC, Menlo Park, CA (US)

(72) Inventors: Zuoqian Wang, Santa Clara, CA (US); Min Tao, San Jose, CA (US); Anqi Ji, Redwood City, CA (US); Serge Bierhuizen, Cupertino, CA (US); Chao Han, San Ramon, CA (US); Shizhe Shen, Foster City, CA (US); Adam Alan Mudrick, San Carlos, CA (US); Jonah Shaver, Sunnyvale, CA (US); Ruiqing Ma, Kirkland, WA (US); Alexander Randon Cope, Portland, OR (US)

(21) Appl. No.: 19/045,677

(22) Filed: Feb. 5, 2025

Related U.S. Application Data
(60) Provisional application No. 63/549,821, filed on Feb. 5, 2024.

(51) Int. Cl. G06F 3/01; G02B 27/01; G06T 7/70

(52) U.S. Cl. CPC G06F 3/013; G02B 27/0179; G06F 3/012; G06T 7/70; G02B 2027/0187; G06T 2207/10016; G06T 2207/30201

(57) ABSTRACT

A head mounted display for eye and face tracking includes an optical assembly arranged proximate to a user's eyes, a display panel arranged behind the optical assembly and visible to the user through the optical assembly along a line of sight of the user, a camera arranged within the display panel so that the user's eyes are visible to the camera through the optical assembly, and a light source arranged proximate to the camera so that light from the light source is incident upon the user's eyes through the optical assembly.

### CROSS-REFERENCE TO RELATED APPLICATIONS

This application claims the benefit of U.S. Provisional Patent Application No. 63/549,821, to Zuoqian Wang et al., filed on Feb. 5, 2024, the disclosures of all of these applications and patents are incorporated by reference herein.

### TECHNICAL FIELD

The present disclosure generally relates to head mounted displays, and more particularly to eye and face tracking for users wearing head mounted displays.

### BACKGROUND

In head mounted displays (HMDs), cameras and light-emitting diodes (LEDs) for eye tracking and/or face tracking are typically located around the optical lens, or alternatively located behind the lens but all in front of or outside of the display panels. There are high manufacturing and integration challenges with cameras and LEDs surrounding or inside the optical modules of HMD. The eye tracking and/or face tracking performance is not ideal due to camera and LED light distortions, and the position of the cameras and LEDs risks interfering with the display and optical viewing experiences.

As such, there is a need for improved positioning of the cameras and/or LEDs to improve the tracking performance without interfering with the user experience.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a head mounted display for eye and face tracking. The head mounted display also includes an optical assembly arranged proximate to a user's eyes; a display panel arranged behind the optical assembly and visible to the user through the optical assembly along a line of sight of the user, a camera arranged so that the user's eyes are visible to the camera through the optical assembly, and a light source arranged so that light from the light source is incident upon the user's eyes through the optical assembly. Other embodiments of this aspect include corresponding computer systems, apparatus, and computer programs recorded on one or more computer storage devices, each configured to perform the actions of the methods.

One general aspect includes a system for eye and face tracking. The system also includes a processor. The system also includes a head mounted display in communication with the processor, the head mounted display may include: an optical assembly arranged proximate to a user's eyes, a display panel arranged behind the optical assembly and visible to the user through the optical assembly along a line of sight of the user, a camera arranged so that the user's eyes are visible to the camera through the optical assembly, and a light source so that light from the light source is incident upon the user's eyes through the optical assembly. The system also includes a non-transitory computer readable medium storing a set of instructions, which when executed by the processor, configure the processor to: display to the user a real-time video on the display panel, receive a signal from the camera, process the signal to generate tracking data associated with the user's eyes and face, and adjust the real-time video based on the tracking data. Other embodiments of this aspect include corresponding computer systems, apparatus, and computer programs recorded on one or more computer storage devices, each configured to perform the actions of the methods.

One general aspect includes a method for eye and face tracking. The method also includes displaying to a user a real-time video on a display panel arranged behind an optical assembly, the display panel visible to a user through the optical assembly along a line of sight of the user. The method also includes receiving a signal from a camera arranged within the display panel so that the user's eyes are visible to the camera through the optical assembly, the user's eyes illuminated by a light source arranged proximate to the camera so that light from the light source is incident upon the user's eyes through the optical assembly. The method also includes processing the signal to generate tracking data associated with the user's eyes and face. The method also includes adjusting the real-time video based on the tracking data. Other embodiments of this aspect include corresponding computer systems, apparatus, and computer programs recorded on one or more computer storage devices, each configured to perform the actions of the methods.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments.

FIG. 1 illustrates a network architecture used to implement eye and face tracking, according to some embodiments.

FIG. 2 is a block diagram illustrating details of a system for eye and face tracking, according to some embodiments.

FIG. 3A illustrates a virtual reality head-mounted display (HMD), according to some embodiments.

FIG. 3B illustrates a mixed reality HMD system which includes a mixed reality HMD and a core processing component, according to some embodiments.

FIG. 3C illustrates controllers that a user can hold in one or both hands to interact with an artificial reality environment presented by the HMDs of FIGS. 3A and 3B, according to some embodiments.

FIG. 4 shows a head-mounted display for eye and face tracking, according to some embodiments.

FIG. 5 shows another head-mounted display for eye and face tracking, according to some embodiments.

FIG. 6 shows another head-mounted display for eye and face tracking, according to some embodiments.

FIG. 7 shows another head-mounted display for eye and face tracking, according to some embodiments.

FIG. 8 is a flowchart illustrating a process for eye and face tracking, according to some embodiments.

FIG. 9 is a block diagram illustrating an exemplary computer system with which aspects of the subject technology can be implemented, according to some embodiments.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

The term “mixed reality” or “MR” as used herein refers to a form of reality that has been adjusted in some manner before presentation to a user, which may include, e.g., virtual reality (VR), augmented reality (AR), extended reality (XR), hybrid reality, or some combination and/or derivatives thereof. Mixed reality content may include completely generated content or generated content combined with captured content (e.g., real-world photographs). The mixed reality content may include video, audio, haptic feedback, or some combination thereof, any of which may be presented in a single channel or in multiple channels (such as stereo video that produces a three-dimensional (3D) effect to the viewer). Additionally, in some embodiments, mixed reality may be associated with applications, products, accessories, services, or some combination thereof, that are, e.g., used to interact with content in an immersive application. The mixed reality system that provides the mixed reality content may be implemented on various platforms, including a head-mounted display (HMD) connected to a server, a host computer system, a standalone HMD, a mobile device or computing system, a “cave” environment or other projection system, or any other hardware platform capable of providing mixed reality content to one or more viewers. Mixed reality may be equivalently referred to herein as “artificial reality.”

“Virtual reality” or “VR,” as used herein, refers to an immersive experience where a user's visual input is controlled by a computing system. “Augmented reality” or “AR” as used herein refers to systems where a user views images of the real-world after they have passed through a computing system. For example, a tablet with a camera on the back can capture images of the real-world and then display the images on the screen on the opposite side of the tablet from the camera. The tablet can process and adjust or “augment” the images as they pass through the system, such as by adding virtual objects. AR also refers to systems where light entering a user's eye is partially generated by a computing system and partially composes light reflected off objects in the real-world. For example, an AR headset could be shaped as a pair of glasses with a pass-through display, which allows light from the real-world to pass through a waveguide that simultaneously emits light from a projector in the AR headset, allowing the AR headset to present virtual objects intermixed with the real objects the user can sec. The AR headset may be a block-light headset with video pass-through. “Mixed reality” or “MR,” as used herein, refers to any of VR, AR, XR, or any combination or hybrid thereof.

The term “eye and face tracking” (ET/FT) as used herein, refers, according to some embodiments, to incorporation of specialized sensors and cameras within a head mounted display, combined with sophisticated software algorithms, to capture and analyze the user's eye movements, gaze direction, and facial expressions in real-time. Use of ET/FT enhances the immersive nature of MR experiences by facilitating natural and responsive interaction with virtual environments based on the user's eye and facial gestures. Accurate tracking of eye movements, gaze direction, and facial expressions enables rendering lifelike virtual content, optimizing user engagement, and providing an intuitive interface for seamless navigation and control within MR scenarios. The application of this technology may be advantageous in gaming, simulation, training, medical, surgical, and healthcare applications, where precise and instantaneous eye and facial tracking significantly contribute to the overall authenticity and effectiveness of the user experience.

Embodiments of the present disclosure address the above identified problems with eye and face tracking in head mounted displays, by using cameras and LEDs that are directly integrated inside, or located behind, a display panel of the head mounted display. Display panels may include, but are not limited to, LCD, OLED, uOLED and uLED display panels, and may be used in single display or dual display panel architectures.

In some embodiments, cameras and/or LEDs may be placed either straight or angled towards the eyes or human faces. A single camera or multiple cameras may be used, as well as one or more LEDs depending on ET/FT performance requirements. The cameras and LEDs may be placed out of the field-of-view (FOV) of the human eye at the perimeter of the display panel, e.g., by using a wide-FOV camera. Infrared (IR) LEDs for ET purposes may be placed at selective panel locations, alongside and/or interleaved with RGB LEDs for display.

As an example, for implementation on displays with transparent substrates, the ET LED/camera may be placed directly underneath the display outside of the center region. In this region, high resolution may not be needed. An ET LED/camera may be placed directly underneath the display outside of the center region, where a lower resolution display (typically measured in pixels per inch, or PPI) can be used. The region with unneeded pixels can be left transparent to provide light path for ET operation.

In some embodiments, the display only emits light part of the time (e.g., about 10% of frame time). An ET operation may be done during the rest of the time to allow minimum interference with the display.

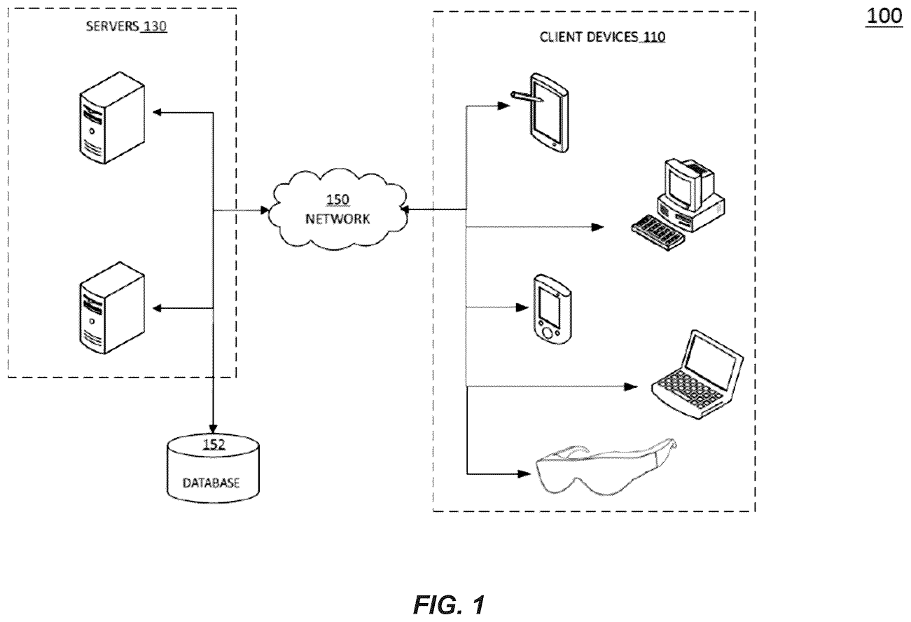

FIG. 1 illustrates a network architecture 100 for eye and face tracking, according to some embodiments. The network architecture 100 may include one or more client devices 110 and servers 130, communicatively coupled via a network 150 with each other and to at least one database, e.g. database 152. Database 152 may store data and files associated with the servers 130 and/or the client devices 110. In some embodiments, client devices 110 collect data, video, images, and the like, for upload to the servers 130 to store in the database 152.

The network 150 may include a wired network (e.g., fiber optics, copper wire, telephone lines, and the like) and/or a wireless network (e.g., a satellite network, a cellular network, a radiofrequency (RF) network, Wi-Fi, Bluetooth, and the like). The network 150 may further include one or more of a local area network (LAN), a wide area network (WAN), the Internet, and the like. Further, the network 150 may include, but is not limited to, any one or more of the following network topologies, including a bus network, a star network, a ring network, a mesh network, and the like.

Client devices 110 may include, but are not limited to, laptop computers, desktop computers, and mobile devices such as smart phones, tablets, televisions, wearable devices, head-mounted devices, display devices, and the like.

In some embodiments, the servers 130 may be a cloud server or a group of cloud servers. In other embodiments, some or all of the servers 130 may not be cloud-based servers (i.e., may be implemented outside of a cloud computing environment, including but not limited to an on-premises environment), or may be partially cloud-based. Some or all of the servers 130 may be part of a cloud computing server, including but not limited to rack-mounted computing devices and panels. Such panels may include but are not limited to processing boards, switchboards, routers, and other network devices. In some embodiments, the servers 130 may include the client devices 110 as well, such that they are peers.

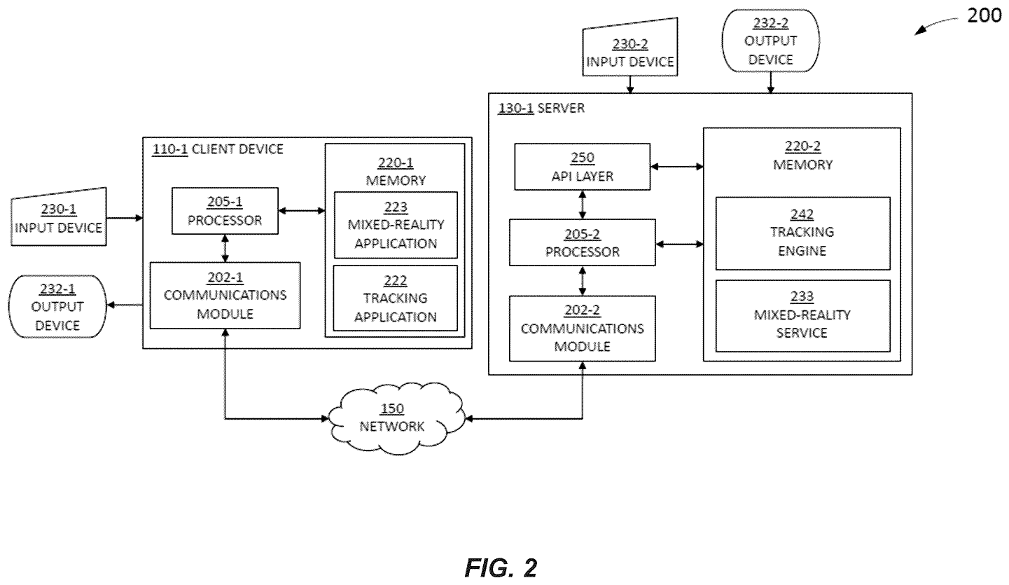

FIG. 2 is a block diagram illustrating details of a system 200 for eye and face tracking, according to some embodiments. Specifically, the example of FIG. 2 illustrates an exemplary client device 110-1 (of the client devices 110) and an exemplary server 130-1 (of the servers 130) in the network architecture 100 of FIG. 1.

Client device 110-1 and server 130-1 are communicatively coupled over network 150 via respective communications modules 202-1 and 202-2 (hereinafter, collectively referred to as “communications modules 202”). Communications modules 202 are configured to interface with network 150 to send and receive information, such as requests, data, messages, commands, and the like, to other devices on the network 150. Communications modules 202 can be, for example, modems or Ethernet cards, and/or may include radio hardware and software for wireless communications (e.g., via electromagnetic radiation, such as radiofrequency (RF), near field communications (NFC), Wi-Fi, and Bluetooth radio technology).

The client device 110-1 and server 130-1 also include processors 205-1 and 205-2 and memories 220-1 and 220-2, respectively. Processors 205-1 and 205-2 and memories 220-1 and 220-2 will be collectively referred to, hereinafter, as “processors 205,” and “memories 220.” Processors 205 may be configured to execute instructions stored in memories 220, to cause client device 110-1 and/or server 130-1 to perform methods and operations consistent with embodiments of the present disclosure.

The client device 110-1 and the server 130-1 are each coupled to at least one input device 230-1 and input device 230-2, respectively (hereinafter, collectively referred to as “input devices 230”). The input devices 230 can include a mouse, a controller, a keyboard, a pointer, a stylus, a touchscreen, a microphone, voice recognition software, a joystick, a virtual joystick, a touch-screen display, and the like. In some embodiments, the input devices 230 may include cameras, microphones, sensors, and the like. The input devices 230 may include, for example, face-tracking cameras and/or eye-tracking cameras. In some embodiments, the sensors may include touch sensors, acoustic sensors, inertial motion units and the like.

The client device 110-1 and the server 130-1 are also coupled to at least one output device 232-1 and output device 232-2, respectively (hereinafter, collectively referred to as “output devices 232”). The output devices 232 may include a screen, a display (e.g., a same touchscreen display used as an input device), a speaker, an alarm, and the like. A user may interact with client device 110-1 and/or server 130-1 via the input devices 230 and the output devices 232.

Memory 220-1 may further include a tracking application 222, configured to execute on client device 110-1 and couple with input device 230-1 and output device 232-1. The tracking application 222 may be downloaded by the user from server 130-1, and/or may be hosted by server 130-1. The tracking application 222 may include specific instructions which, when executed by processor 205-1, cause operations to be performed consistent with embodiments of the present disclosure. In some embodiments, the tracking application 222 runs on an operating system (OS) installed in client device 110-1. In some embodiments, tracking application 222 may run within a web browser. In some embodiments, the processor 205-1 is configured to control a graphical user interface (GUI) (e.g., spanning at least a portion of input devices 230 and output devices 232) for the user of client device 110-1 to access the server 130-1.

In some embodiments, memory 220-2 includes a tracking engine 242. The tracking engine 242 may be configured to perform methods and operations consistent with embodiments of the present disclosure. The tracking engine 242 may share or provide features and resources with the client device 110-1, including data, libraries, and/or applications retrieved with tracking engine 242 (e.g., tracking application 222). The user may access the tracking engine 242 through the tracking application 222. The tracking application 222 may be installed in client device 110-1 by the tracking engine 242 and/or may execute scripts, routines, programs, applications, and the like provided by the tracking engine 242.

Memory 220-1 may further include a mixed reality application 223, configured to execute in client device 110-1 and couple with input device 230-1 and output device 232-1. The mixed reality application 223 may be downloaded by the user from server 130-1, and/or may be hosted by server 130-1. The mixed reality application 223 may include specific instructions which, when executed by processor 205-1, cause operations to be performed consistent with embodiments of the present disclosure. In some embodiments, the mixed reality application 223 runs on an operating system (OS) installed in client device 110-1. In some embodiments, mixed reality application 223 may run within a web browser.

The mixed reality application 223 may communicate with a mixed reality service 233 in memory 220-2 to provide a mixed reality environment or experience to a user of client device 110-1. The mixed reality application 223 may communicate with mixed reality service 233 through API layer 250, for example. The tracking application may receive sensor information from the input devices 230 and provide that information to the mixed reality application 223.

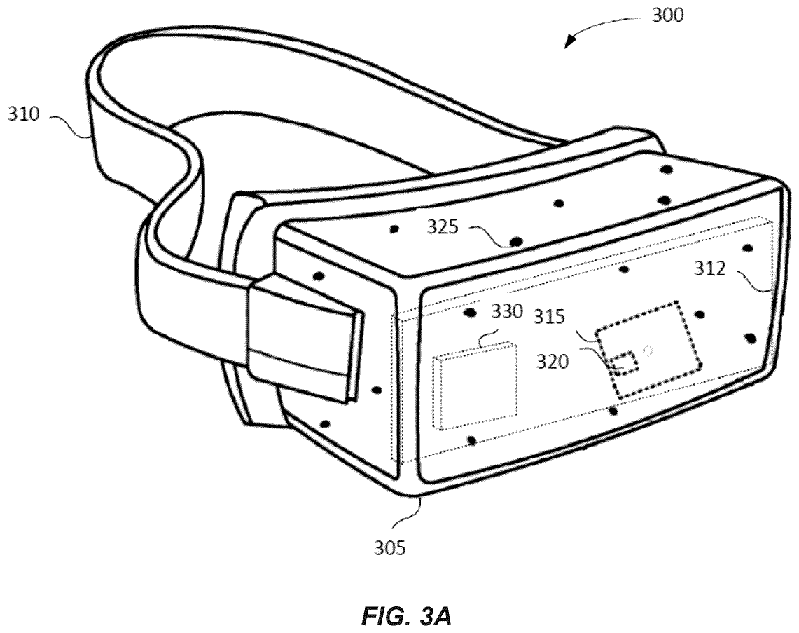

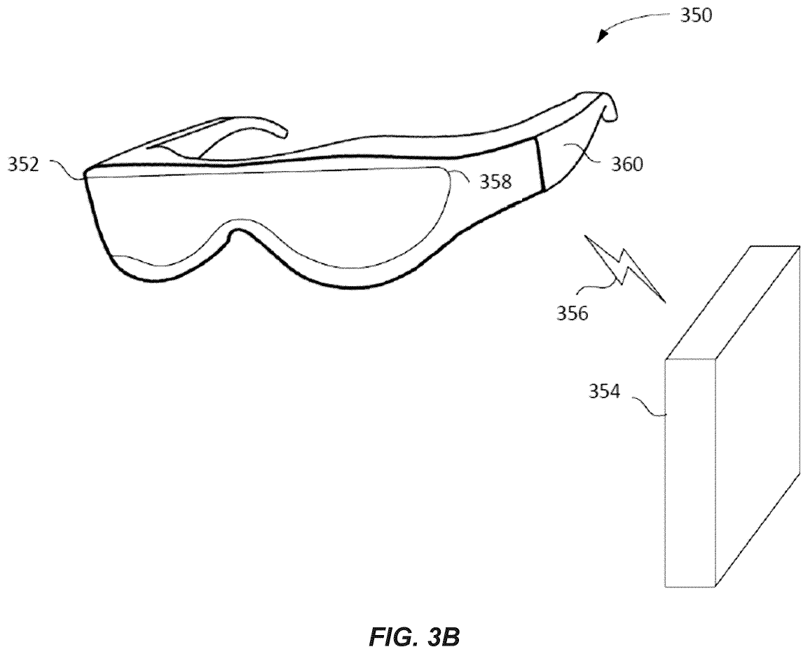

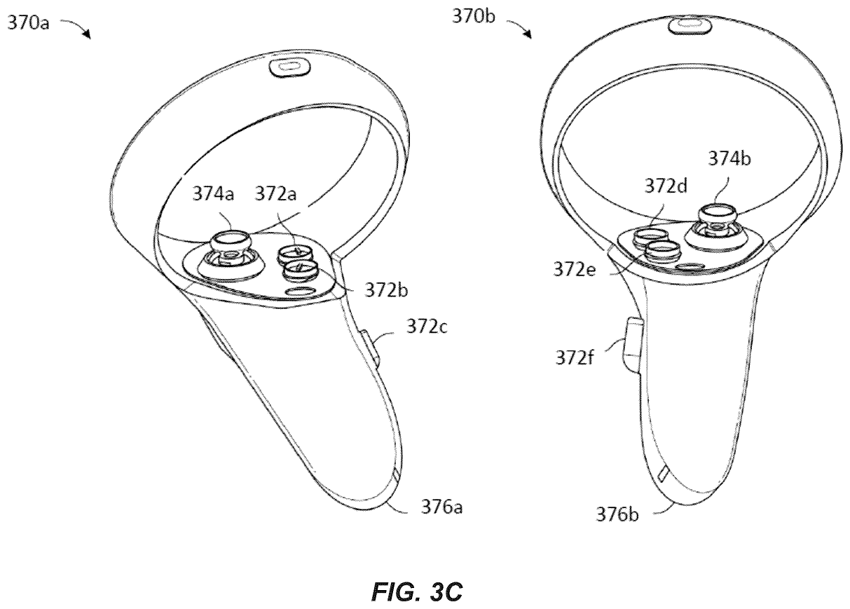

FIGS. 3A-3B are diagrams illustrating virtual reality headsets, according to certain aspects of the present disclosure. FIG. 3A is a diagram of a virtual reality/mixed reality head-mounted display (VR/MR HMD) 300. In various embodiments, the VR/MR HMD 300 may be used, as one or more of client devices 110 (e.g., as a non-limiting example, client device 110-1) or as one or more of servers 130 (e.g., as a non-limiting example, server 130-1).

The VR/MR HMD 300 includes a front rigid body 305 and a band 310. The front rigid body 305 includes one or more electronic display elements such as an electronic display 312, an inertial motion unit (IMU) 315, one or more position sensors 320, locators 325, and one or more compute units 330. The position sensors 320, the IMU 315, and compute units 330 may be internal to the VR/MR HMD 300 and may not be visible to the user. In various implementations, the IMU 315, position sensors 320, and locators 325 may track movement and location of the VR/MR HMD 300 in the real world and in a virtual environment in three degrees of freedom (3DoF), six degrees of freedom (6DoF), etc. For example, the locators 325 may emit infrared light beams which create light points on real objects around the VR/MR HMD 300. As another example, the IMU 315 may include, e.g., one or more accelerometers, gyroscopes, magnetometers, other non-camera-based position, force, or orientation sensors, or combinations thereof. One or more cameras (not shown) integrated with the VR/MR HMD 300 may detect the light points, such as for a computer vision algorithm or module. The compute units 330 in the VR/MR HMD 300 may use the detected light points to extrapolate position and movement of the VR/MR HMD 300 as well as to identify the shape and position of the real objects surrounding the VR/MR HMD 300.

The electronic display 312 may be integrated with the front rigid body 305 and may provide image light to a user as dictated by the compute units 330. In various embodiments, the electronic display 312 may be a single electronic display or multiple electronic displays (e.g., a display for each user eye). Examples of the electronic display 312 include: a liquid crystal display (LCD), an organic light-emitting diode (OLED) display, an active-matrix organic light-emitting diode display (AMOLED), a display including one or more quantum dot light-emitting diode (QOLED) sub-pixels, a projector unit (e.g., microLED, LASER, etc.), some other display, or some combination thereof. The electronic display 312 may be coupled with an audio component, such as sending and receiving output from various other users of the XR environment wearing their own XR headsets, for example. The audio component may be configured to host multiple audio channels, sources, or modes.

In some implementations, the VR/MR HMD 300 may be coupled to a core processing component such as a personal computer (PC) (not shown) and/or one or more external sensors (not shown). The external sensors may monitor the VR/MR HMD 300 (e.g., via light emitted from the VR/MR HMD 300) which the PC may use, in combination with output from the IMU 315 and position sensors 320, to determine the location and movement of the VR/MR HMD 300.

FIG. 3B is a diagram of an HMD system 350 which includes a mixed reality (MR) HMD 352 and a core processing component 354. HMD system 350 may also include additional components not shown in FIG. 3B, including but not limited to input components, tracking components, and output components. In various embodiments, components of HMD system 350 may be used, as one or more of client devices 110 (e.g., as a non-limiting example, client device 110-1) or as one or more of servers 130 (e.g., as a non-limiting example, server 130-1).

In various embodiments, the MR HMD 352 may be used, as one or more of client devices 110 (e.g., as a non-limiting example, client device 110-1) or as one or more of servers 130 (e.g., as a non-limiting example, server 130-1).

The MR HMD 352 and the core processing component 354 may communicate via a wireless connection (e.g., a 60 GHz link) as indicated by the link 356. In other implementations, the HMD system 350 includes a headset only, without an external compute device or includes other wired or wireless connections between the MR HMD 352 and the core processing component 354. The MR HMD 352 includes a pass-through display 358 and a frame 360. The frame 360 may house various electronic components (not shown) such as light projectors (e.g., LASERs, LEDs, etc.), cameras, eye-tracking sensors, MEMS components, networking components, etc. The frame 360 or another part of the MR HMD 352 may include an audio electronic component such as a speaker (not shown in FIG. 3B). The speaker may output audio from various audio sources, such as a phone call, VOIP session, or other audio channel. The electronic components may be configured to implement audio switching based on user gaming or XR interactions.

The projectors may be coupled to the pass-through display 358, e.g., via optical elements, to display media to a user. The optical elements may include one or more waveguide assemblies, reflectors, lenses, mirrors, collimators, gratings, etc., for directing light from the projectors to a user's eye. Image data may be transmitted from the core processing component 354 via link 356 to MR HMD 352. Controllers in the MR HMD 352 may convert the image data into light pulses from the projectors, which may be transmitted via the optical elements as output light to the user's eye. The output light may mix with light that passes through the pass-through display 358, allowing the output light to present virtual objects that appear as if they exist in the real world.

Similarly to the VR/MR HMD 300, the HMD system 350 may also include motion and position tracking units, cameras, light sources, etc., which allow the HMD system 350 to, e.g., track itself in 3DoF or 6DoF, track portions of the user (e.g., hands, feet, head, or other body parts), map virtual objects to appear as stationary as the MR HMD 352 moves, and have virtual objects react to gestures and other real-world objects. For example, the HMD system 350 may track the motion and position of the user's wrist movements as input gestures for performing XR navigation. As an example, the HMD system 350 may include a coordinate system to track the relative positions of various XR objects and elements in a shared artificial reality environment.

FIG. 3C illustrates controllers 370a-370b, which, in some implementations, a user may hold in one or both hands to interact with an artificial reality environment presented by the VR/MR HMD 300 and/or MR HMD 352. In various embodiments, the controllers 370a-370b may be used, as one or more of client devices 110 (e.g., as a non-limiting example, client device 110-1) or as one or more of servers 130 (e.g., as a non-limiting example, server 130-1).

The controllers 370a-370b may be in communication with the HMDs, either directly or via an external device (e.g., core processing component 354). The controllers may have some or all of their own IMU units, position sensors, processors, cameras, and/or light emitters. The VR/MR HMD 300 or MR HMD 352, external sensors, or sensors in the controllers 370a-370b may be used to track controllers 370a-370b to determine the positions and/or orientations thereof (e.g., to track the controllers in 3DoF or 6DoF). As an example, the compute units 330 in the VR/MR HMD 300 or the core processing component 354 may use this tracking, either alone or in combination with IMU and/or position sensor output, to monitor hand positions and motions of the user. For example, the compute units 330 may use the monitored hand positions to implement navigation and scrolling via the hand positions and motions of the user, such as to enable a high fiving motion in XR.

The controllers 370a-370b may also include various buttons (e.g., buttons 372a-f) and/or joysticks (e.g., joysticks 374a-b), which a user may actuate to provide input and interact with objects. As discussed below, controllers 370a-370b may also have tips 376a and 376b, which, when in scribe controller mode, may be used as the tip of a writing implemented in the artificial reality environment. In various implementations, the VR/MR HMD 300 or MR HMD 352 may also include additional subsystems, such as a hand tracking unit, an eye tracking unit, an audio system, various network components, etc., to monitor indications of user interactions and intentions. For example, in some implementations, instead of or in addition to controllers, one or more cameras included in the VR/MR HMD 300 or MR HMD 352, or from external cameras, may monitor the positions and poses of the user's hands to determine gestures and other hand and body motions. Such camera-based hand tracking may be referred to as computer vision, for example. Sensing subsystems of the VR/MR HMD 300 or MR HMD 352 may be used to define motion (e.g., user hand/wrist motion) along an axis (e.g., three different axes).

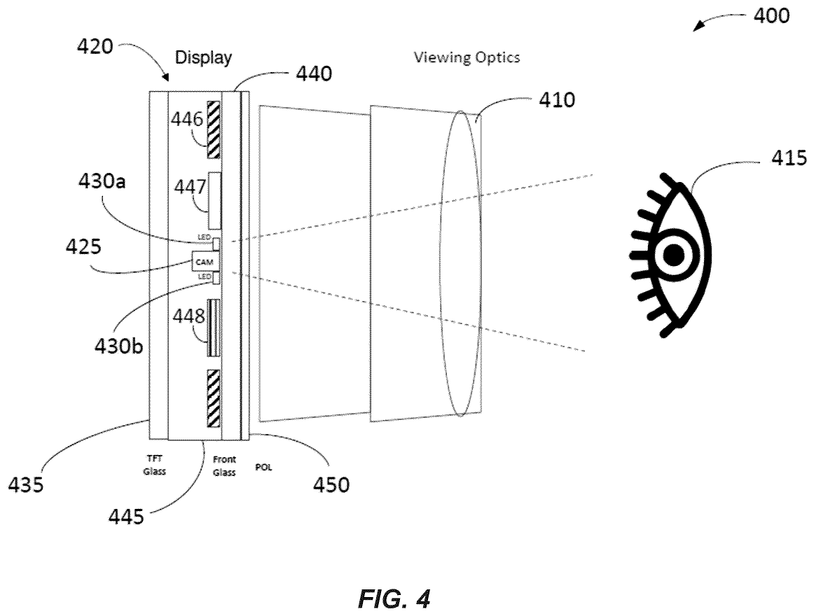

FIG. 4 shows a head mounted display 400 for eye and face tracking, according to some embodiments. The head mounted display 400 may be a virtual reality/mixed reality head-mounted display or a mixed-reality head-mounted display. In this example, the head mounted display 400 includes an optical assembly 410 arranged proximate to the user's eyes 415, and a display panel 420 arranged behind the optical assembly 410. The display panel 420 is visible to the user through the optical assembly 410 along the user's line of sight. The display panel 420 may be any type of panel architecture, including but not limited to a single display panel architecture and a dual display panel architecture.

In the example of FIG. 4, the head mounted display 400 includes a single camera 425 for observing the user's eyes 415 and/or face (not shown), and multiple light sources 430a, 430b to provide illumination for the camera 425. The camera 425 is arranged within the display panel 420 so that the user's eyes 415 and/or face are visible to the camera 425 through the optical assembly 410. In this example, the camera 425 is positioned along, and oriented parallel to, the user's line of sight. The dashed lines indicate the field of view of the camera 425.

In this example, the light sources 430a, 430b are arranged proximate to the camera 425 and oriented so that light from the light sources 430a, 430b is incident upon the user's eyes 415 and/or face through the optical assembly 410 to provide sufficient illumination for the camera 425. Specifically, the light sources 430a, 430b are oriented parallel to the user's line of sight.

In the example of FIG. 4, the display panel 420 is a liquid crystal display (LCD) panel comprising a thin-film transistor (TFT) layer 435 (including a glass substrate), a front glass layer 440, and a liquid crystal layer 445 arranged between the TFT layer 435 and the front glass layer 440. The liquid crystal layer 445 includes an array of pixels, each pixel having sub-pixels for the color red (sub-pixel 446), green (sub-pixel 447), and blue (sub-pixel 448). LCD panel may also have additional components, including but not limited to at least one polarization layer 450.

In this example, the light sources 430a, 430b are an array of two or more light-emitting diode (LED) lights arranged around the camera 425, within the liquid crystal layer 445. The light sources 430a, 430b may generate infrared light or other wavelengths of light that are not visible to the user's eyes 415, but which are detectable by the camera 425. Alternatively, the light sources 430a, 430b may in some embodiments be located external to the liquid crystal layer 445, but still oriented so that light from the light sources 430a, 430b is incident upon the user's eyes 415 and/or face and provide sufficient illumination for the camera 425.

As discussed above, the embodiment shown in FIG. 4 is an LCD panel. In other embodiments, the display panel 420 may be one of a light-emitting diode (LED) display panel, an organic LED display panel, a micro-OLED display panel, and a micro-LED display panel.

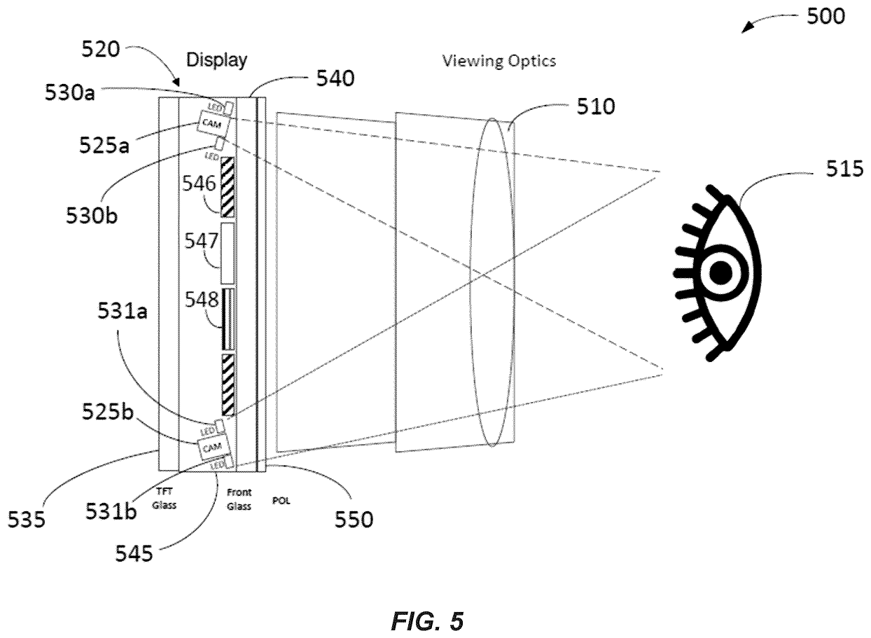

FIG. 5 shows another head mounted display 500 for eye and face tracking, according to some embodiments. The head mounted display 500 may be a virtual reality/mixed reality head-mounted display or a mixed-reality head-mounted display. The head mounted display 500 is similar to the embodiment of the head mounted display 400 discussed above with respect to FIG. 4, and like reference numerals have been used to refer to the same or similar components. A detailed description of these components will be omitted, and the following discussion focuses on the differences between these embodiments. Any of the various features discussed with any one of the embodiments discussed herein may also apply to and be used with any other embodiments.

In this example, the head mounted display 500 includes an optical assembly 410 arranged proximate to the user's eyes 515, and a display panel 520 arranged behind the optical assembly 510. The display panel 520 is visible to the user through the optical assembly 510 along the user's line of sight. The display panel 520 may be any type of panel architecture, including but not limited to a single display panel architecture and a dual display panel architecture.

In the example of FIG. 5, the head mounted display 500 also includes two or more cameras 525a, 525b for observing the user's eyes 515 and/or face (not shown). The head mounted display 500 further includes two or more light sources 530a, 530b to provide illumination for the camera 525a, and two or more light sources 531a, 531b to provide illumination for the camera 525b.

The cameras 525a, 525b are arranged within the display panel so that the user's eyes 515 and/or face are visible to the cameras 525a, 525b through the optical assembly 510. In this example, the cameras 525a, 525b are each positioned at different locations off of the user's line of sight, and each oriented at different angles relative to the user's line of sight. The dashed lines indicate the field of view of the camera 525a, and the dotted lines indicate the field of view of the camera 525b.

In this example, the light sources 530a, 530b are arranged proximate to the camera 525a and oriented so that light from the light sources 530a, 530b is incident upon the user's eyes 515 and/or face through the optical assembly 510 to provide sufficient illumination for the camera 525a. Likewise, the light sources 531a, 531b are arranged proximate to the camera 525b and oriented so that light from the light sources 531a, 531b is incident upon the user's eyes 515 and/or face through the optical assembly 510 to provide sufficient illumination for the camera 525b. Specifically, in this example, the light sources 530a, 530b are oriented at the same angle relative to the user's line of sight as camera 525a, and the light sources 531a, 531b are oriented at the same angle relative to the user's line of sight as camera 525b.

In the example of FIG. 5, the display panel 520 is a liquid crystal display (LCD) panel comprising a thin-film transistor (TFT) layer 535 (including a glass substrate), a front glass layer 540, and a liquid crystal layer 545 arranged between the TFT layer 535 and the front glass layer 540. The liquid crystal layer 545 includes an array of pixels, each pixel having sub-pixels for the color red (sub-pixel 546), green (sub-pixel 547), and blue (sub-pixel 548). The LCD panel may also have additional components, including but not limited to at least one polarization layer 550.

In this example, the light sources 530a, 530b are an array of two or more light-emitting diode (LED) lights arranged around the camera 525a, within the liquid crystal layer 545. The light sources 530a, 530b may generate infrared light or other wavelengths of light that are not visible to the user's eyes 515, but which are detectable by the camera 525a. Alternatively, the light sources 530a, 530b may in some embodiments be located external to the liquid crystal layer 545, but still oriented so that light from the light sources 530a, 530b is incident upon the user's eyes 515 and/or face and provide sufficient illumination for the camera 525a.

In addition, in this example, the light sources 531a, 531b are an array of two or more light-emitting diode (LED) lights arranged around the camera 525b, within the liquid crystal layer 545. The light sources 531 may generate infrared light or other wavelengths of light that are not visible to the user's eyes 515, but which are detectable by the camera 525b. Alternatively, the light sources 531a, 531b may in some embodiments be located external to the liquid crystal layer 545, but still oriented so that light from the light sources 531a, 531b is incident upon the user's eyes 515 and/or face and provide sufficient illumination for the camera 525b.

As discussed above, the embodiment shown in FIG. 5 is an LCD panel. In other embodiments, the display panel 520 may be one of a light-emitting diode (LED) display panel, an organic LED display panel, a micro-OLED display panel, and a micro-LED display panel.

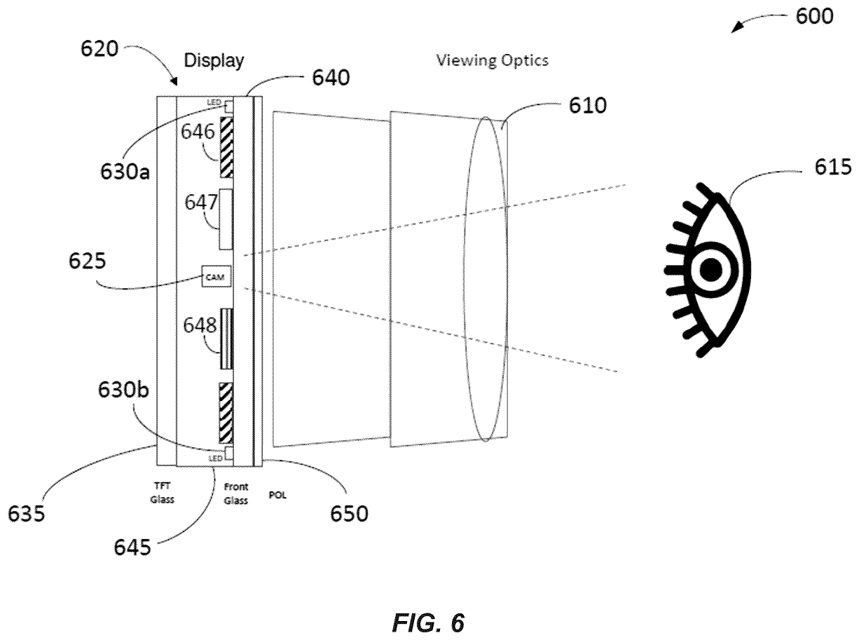

FIG. 6 shows another head mounted display 600 for eye and face tracking, according to some embodiments. The head mounted display 600 may be a virtual reality/mixed reality head-mounted display or a mixed-reality head-mounted display. The head mounted display 600 is similar to the embodiments of the head mounted display 400 and head mounted display 500 discussed above with respect to FIG. 4 and FIG. 5, and like reference numerals have been used to refer to the same or similar components. A detailed description of these components will be omitted, and the following discussion focuses on the differences between these embodiments. Any of the various features discussed with any one of the embodiments discussed herein may also apply to and be used with any other embodiments.

In this example, the head mounted display 600 includes an optical assembly 610 arranged proximate to the user's eyes 615, and a display panel 620 arranged behind the optical assembly 610. The display panel 620 is visible to the user through the optical assembly 610 along the user's line of sight. The display panel 620 may be any type of panel architecture, including but not limited to a single display panel architecture and a dual display panel architecture.

In the example of FIG. 6, the head mounted display 600 includes a single camera 625 for observing the user's eyes 615 and/or face (not shown), and multiple light sources 630a, 630b to provide illumination for the camera 625. The camera 625 is arranged within the display panel 620 so that the user's eyes 615 and/or face are visible to the camera 625 through the optical assembly 610. In this example, the camera 625 is positioned along, and oriented parallel to, the user's line of sight. The dashed lines indicate the field of view of the camera 625.

In this example, the light sources 630a, 630b are arranged within the display panel 620, but are not arranged proximate to the camera 625. The light sources 630a, 630b are oriented so that light from the light sources 630a, 630b is incident upon the user's eyes 615 and/or face through the optical assembly 610 to provide sufficient illumination for the camera 625. Specifically, in this example, the light sources 630a, 630b are oriented at different offset angles relative to each other and relative to the user's line of sight.

In the example of FIG. 6, the display panel 620 is a liquid crystal display (LCD) panel comprising a thin-film transistor (TFT) layer 635 (including a glass substrate), a front glass layer 640, and a liquid crystal layer 645 arranged between the TFT layer 635 and the front glass layer 640. The liquid crystal layer 645 includes an array of pixels, each pixel having sub-pixels for the color red (sub-pixel 646), green (sub-pixel 647), and blue (sub-pixel 648). The LCD panel may also have additional components, including but not limited to at least one polarization layer 650.

In this example, the light sources 630a, 630b are an array of two or more light-emitting diode (LED) lights arranged within the liquid crystal layer 645. The light sources 630a, 630b may generate infrared light or other wavelengths of light that are not visible to the user's eyes 615, but which are detectable by the camera 625. Alternatively, the light sources 630a, 630b may in some embodiments be located external to the liquid crystal layer 645, but still oriented so that light from the light sources 630a, 630b is incident upon the user's eyes 615 and/or face and provide sufficient illumination for the camera 625.

As discussed above, the embodiment shown in FIG. 6 is an LCD panel. In other embodiments, the display panel 620 may be one of a light-emitting diode (LED) display panel, an organic LED display panel, a micro-OLED display panel, and a micro-LED display panel.

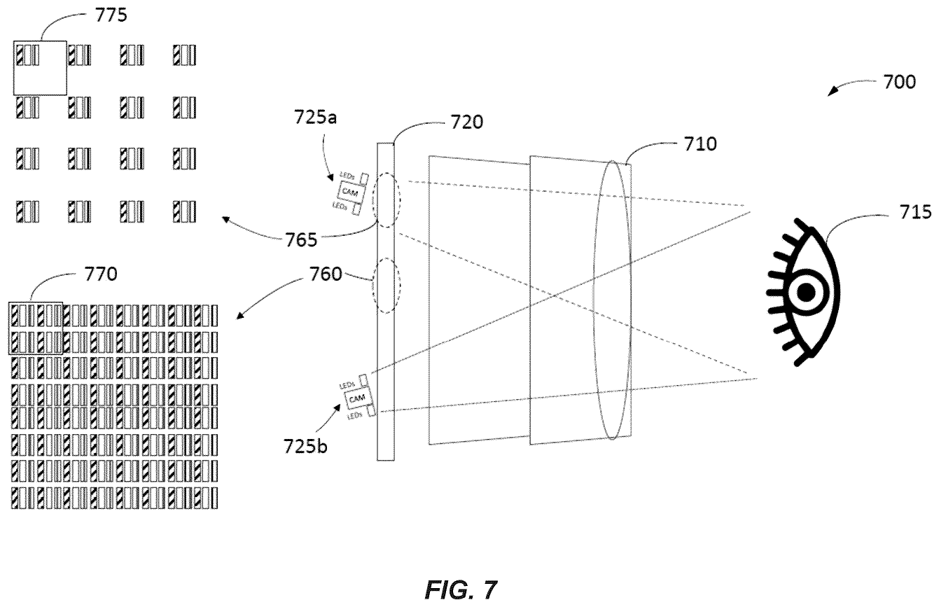

FIG. 7 shows another head mounted display 700 for eye and face tracking, according to some embodiments. The head mounted display 700 may be a virtual reality/mixed reality head-mounted display or a mixed-reality head-mounted display. The head mounted display 700 is similar to the embodiments of the head mounted display 400, head mounted display 500, and head mounted display 600 discussed above with respect to FIGS. 4-6, and like reference numerals have been used to refer to the same or similar components. A detailed description of these components will be omitted, and the following discussion focuses on the differences between these embodiments. Any of the various features discussed with any one of the embodiments discussed herein may also apply to and be used with any other embodiments.

In this example, the head mounted display 700 includes an optical assembly 710 arranged proximate to the user's eyes 715, and a display panel 720 arranged behind the optical assembly 710. The display panel 720 is visible to the user through the optical assembly 710 along the user's line of sight. The display panel 720 may be any type of panel architecture, including but not limited to a single display panel architecture and a dual display panel architecture.

In the example of FIG. 7, the head mounted display 700 also includes two or more camera assemblies 725a, 725b, each including a camera for observing the user's eyes 715 and/or face (not shown) and one or more light sources to provide illumination for the camera. The dashed lines indicate the field of view of the camera in camera assembly 725a, and the dotted lines indicate the field of view of the camera in camera assembly 725b.

In this embodiment, display 720 has a transparent substrate, and the camera assemblies 725a, 725b are located external to the display panel 720, but still oriented so that each camera's field of view includes the user's eyes 715 and so that light from the light sources is incident upon the user's eyes 715 and/or face and provide sufficient illumination for the cameras. Specifically, the camera assemblies 725a, 725b are arranged directly underneath the display 725 outside of the center region 760. As an example, camera assembly 725a is arranged at peripheral region 765.

In some embodiments, the resolution of the display panel 720 may be lower in the peripheral region 765 of the display panel 720, and higher in the center region 760 of the display panel 720. The resolution may be determined by the density of pixels, such that in the center region 760, the pixels are tightly spaced together in groups of four (see area 770), and in the peripheral region 765, only one pixel is needed for the same area (see area 775, which is the same size as area 770). The extra space in for the unneeded three pixels in area 775 may be left transparent to allow the ET operation.

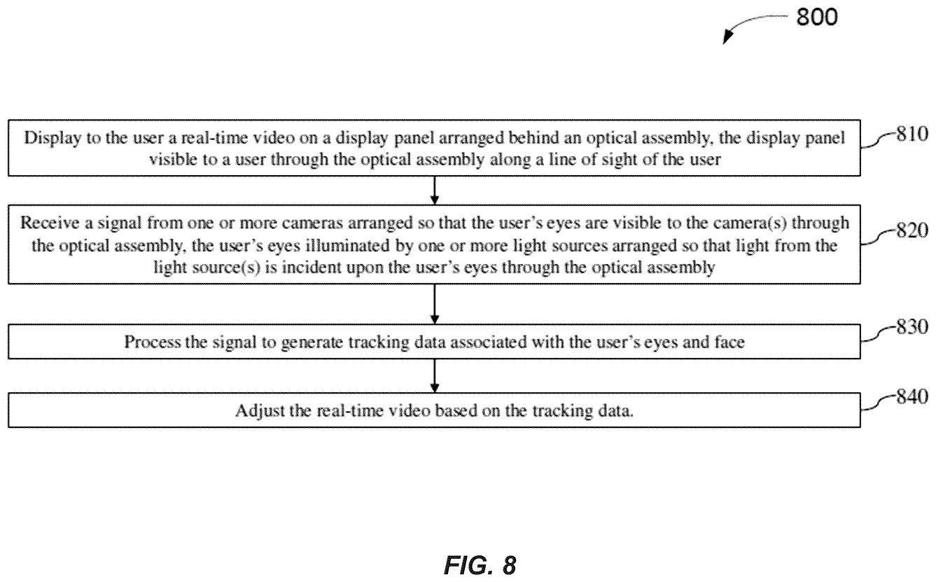

FIG. 8 is a flowchart illustrating a process 800 for eye and face tracking performed by a client device (e.g., client device 110-1, VR/MR HMD 300, MR HMD 352, head mounted display 400, head mounted display 500, head mounted display 600, head mounted display 700, and the like) and/or a client server (e.g., server 130-1, etc.), according to some embodiments. In some embodiments, one or more operations in process 800 may be performed by a processor circuit (e.g., processors 205, etc.) executing instructions stored in a memory circuit (e.g., memories 220, etc.) of a system (e.g., system 200, etc.) as disclosed herein. For example, operations in process 800 may be performed by tracking application 222, tracking engine 242, or some combination thereof. Moreover, in some embodiments, a process consistent with this disclosure may include at least operations in process 800 performed in a different order, simultaneously, quasi-simultaneously, or overlapping in time.

At 810, the process 800 displays to the user a real-time video on a display panel (e.g., display panel 420, display panel 520, display panel 620, display panel 720, and the like) arranged behind an optical assembly (e.g., optical assembly 410, optical assembly 510, optical assembly 610, optical assembly 710, and the like), the display panel visible to a user through the optical assembly along a line of sight of the user.

At 820, the process 800 receives a signal from one or more cameras (e.g., camera 425, camera 525a, camera 525b, camera 625, camera assembly 725a, camera assembly 725b, and the like) arranged so that the user's eyes are visible to the camera(s) through the optical assembly, the user's eyes illuminated by one or more light sources (e.g., light source 430a, light source 430b, light source 530a, light source 530b, light source 531a, light source 531b, light source 630a, light source 630b, and the like) arranged so that light from the light source(s) is incident upon the user's eyes through the optical assembly. In some embodiments, one or more of the camera(s) and/or one or more of the light source(s) may be arranged within the display panel. In some embodiments, one or more of the camera(s) and/or one or more of the light source(s) may be arranged behind the display panel, the display panel having a transparent substrate.

At 830, the process 800 processes the signal to generate tracking data associated with the user's eyes and face.

At 840, the process 800 adjusts the real-time video based on the tracking data.

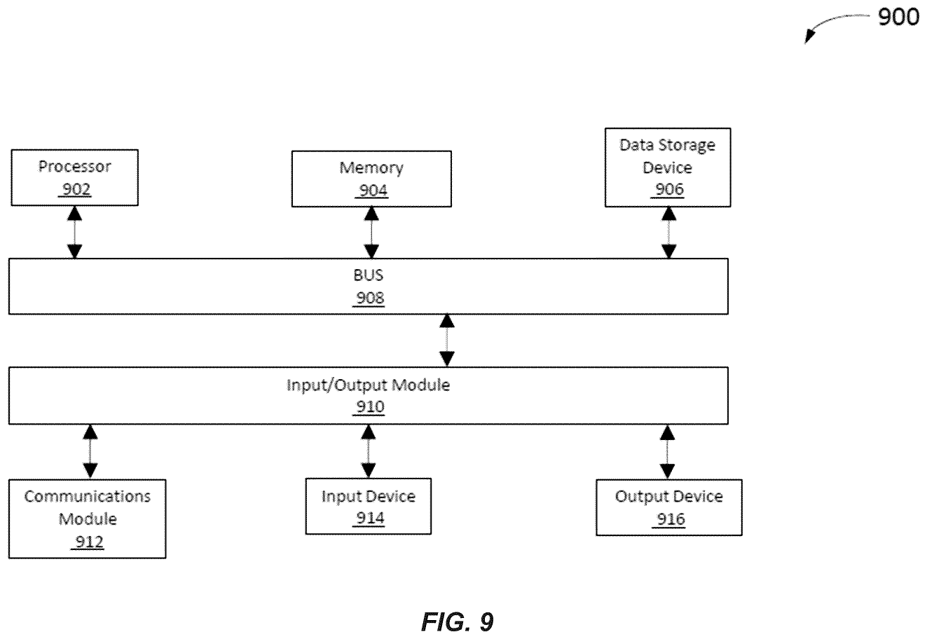

FIG. 9 is a block diagram illustrating an exemplary computer system 900 with which aspects of the subject technology can be implemented. In certain aspects, the computer system 900 may be implemented using hardware or a combination of software and hardware, either in a dedicated server, integrated into another entity, or distributed across multiple entities. As a non-limiting example, the computer system 900 may be one or more of the servers 130 and/or the client devices 110.

Computer system 900 includes a bus 908 or other communication mechanism for communicating information, and a processor 902 coupled with bus 908 for processing information. By way of example, the computer system 900 may be implemented with one or more processors 902. Processor 902 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 900 can include, in addition to hardware, code that creates an execution environment for the computer program in question, e.g., code that constitutes processor firmware, a protocol stack, a database management system, an operating system, or a combination of one or more of them stored in an included memory 904, such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 908 for storing information and instructions to be executed by processor 902. The processor 902 and the memory 904 can be supplemented by, or incorporated in, special purpose logic circuitry.

The instructions may be stored in the memory 904 and implemented in one or more computer program products, i.e., one or more modules of computer program instructions encoded on a computer-readable medium for execution by, or to control the operation of, the computer system 900, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, Wirth languages, and xml-based languages. Memory 904 may also be used for storing temporary variable or other intermediate information during execution of instructions to be executed by processor 902.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 900 further includes a data storage device 906 such as a magnetic disk or optical disk, coupled to bus 908 for storing information and instructions. Computer system 900 may be coupled via input/output module 910 to various devices. The input/output module 910 can be any input/output module. Exemplary input/output modules 910 include data ports such as USB ports. The input/output module 910 is configured to connect to a communications module 912. Exemplary communications modules 912 include networking interface cards, such as Ethernet cards and modems. In certain aspects, the input/output module 910 is configured to connect to a plurality of devices, such as an input device 914 and/or an output device 916. Exemplary input devices 914 include a keyboard and a pointing device, e.g., a mouse or a trackball, by which a user can provide input to the computer system 900. Other kinds of input devices 914 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 916 include display devices such as an LCD (liquid crystal display) monitor, for displaying information to the user.

According to one aspect of the present disclosure, the above-described embodiments may be implemented using a computer system 900 in response to processor 902 executing one or more sequences of one or more instructions contained in memory 904. Such instructions may be read into memory 904 from another machine-readable medium, such as data storage device 906. Execution of the sequences of instructions contained in the main memory 904 causes processor 902 to perform the process steps described herein. One or more processors in a multi-processing arrangement may also be employed to execute the sequences of instructions contained in memory 904. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 900 can include clients and servers. A client and server are generally remote from each other and typically interact through a communication network. The relationship of client and server arises by virtue of computer programs running on the respective computers and having a client-server relationship to each other. Computer system 900 can be, for example, and without limitation, a desktop computer, laptop computer, or tablet computer. Computer system 900 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 902 for execution. Such a medium may take many forms, including, but not limited to, non-volatile media, volatile media, and transmission media. Non-volatile media include, for example, optical or magnetic disks, such as data storage device 906. Volatile media include dynamic memory, such as memory 904. Transmission media include coaxial cables, copper wire, and fiber optics, including the wires that comprise bus 908. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As the computer system 900 reads application data and provides an application, information may be read from the application data and stored in a memory device, such as the memory 904. Additionally, data from the memory 904 servers accessed via a network, the bus 908, or the data storage device 906 may be read and loaded into the memory 904. Although data is described as being found in the memory 904, it will be understood that data does not have to be stored in the memory 904 and may be stored in other memory accessible to the processor 902 or distributed among several media, such as the data storage device 906.

Many of the above-described features and applications may be implemented as software processes that are specified as a set of instructions recorded on a computer-readable storage medium (alternatively referred to as computer-readable media, machine-readable media, or machine-readable storage media). When these instructions are executed by one or more processing unit(s) (e.g., one or more processors, cores of processors, or other processing units), they cause the processing unit(s) to perform the actions indicated in the instructions. Examples of computer-readable media include, but are not limited to, RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, ultra-density optical discs, any other optical or magnetic media, and floppy disks. In one or more embodiments, the computer-readable media does not include carrier waves and electronic signals passing wirelessly or over wired connections, or any other ephemeral signals. For example, the computer-readable media may be entirely restricted to tangible, physical objects that store information in a form that is readable by a computer. In some embodiments, the computer-readable media is non-transitory computer-readable media, or non-transitory computer-readable storage media.

In one or more embodiments, a computer program product (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

While the above discussion primarily refers to microprocessor or multi-core processors that execute software, one or more embodiments are performed by one or more integrated circuits, such as application specific integrated circuits (ASICs) or field programmable gate arrays (FPGAs). In one or more embodiments, such integrated circuits execute instructions that are stored on the circuit itself.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way), all without departing from the scope of the subject technology.

It is understood that any specific order or hierarchy of blocks in the processes disclosed is an illustration of example approaches. Based upon implementation preferences, it is understood that the specific order or hierarchy of blocks in the processes may be rearranged, or that not all illustrated blocks be performed. Any of the blocks may be performed simultaneously. In one or more embodiments, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The subject technology is illustrated, for example, according to various aspects described above. The present disclosure is provided to enable any person skilled in the art to practice the various aspects described herein. The disclosure provides various examples of the subject technology, and the subject technology is not limited to these examples. Various modifications to these aspects will be readily apparent to those skilled in the art, and the generic principles defined herein may be applied to other aspects.

A reference to an element in the singular is not intended to mean “one and only one” unless specifically stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the disclosure.

To the extent that the terms “include,” “have,” or the like is used in the description or the claims, such term is intended to be inclusive in a manner similar to the term “comprise” as “comprise” is interpreted when employed as a transitional word in a claim.

The word “exemplary” is used herein to mean “serving as an example, instance, or illustration.” Any embodiment described herein as “exemplary” is not necessarily to be construed as preferred or advantageous over other embodiments. In one aspect, various alternative configurations and operations described herein may be considered to be at least equivalent.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a configuration may refer to one or more configurations and vice versa.

In one aspect, unless otherwise stated, all measurements, values, ratings, positions, magnitudes, sizes, and other specifications that are set forth in this specification, including in the claims that follow, are approximate, not exact. In one aspect, they are intended to have a reasonable range that is consistent with the functions to which they relate and with what is customary in the art to which they pertain. It is understood that some or all steps, operations, or processes may be performed automatically, without the intervention of a user.

Method claims may be provided to present elements of the various steps, operations, or processes in a sample order, and are not meant to be limited to the specific order or hierarchy presented.

In one aspect, a method may be an operation, an instruction, or a function and vice versa. In one aspect, a claim may be amended to include some or all of the words (e.g., instructions, operations, functions, or components) recited in other one or more claims, one or more words, one or more sentences, one or more phrases, one or more paragraphs, and/or one or more claims.

All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for.”

The Title, Background, and Brief Description of the Drawings of the disclosure are hereby incorporated into the disclosure and are provided as illustrative examples of the disclosure, not as restrictive descriptions. It is submitted with the understanding that they will not be used to limit the scope or meaning of the claims. In addition, in the Detailed Description, it can be seen that the description provides illustrative examples, and the various features are grouped together in various embodiments for the purpose of streamlining the disclosure. This method of disclosure is not to be interpreted as reflecting an intention that the included subject matter requires more features than are expressly recited in any claim. Rather, as the claims reflect, inventive subject matter lies in less than all features of a single disclosed configuration or operation. The claims are hereby incorporated into the Detailed Description, with each claim standing on its own to represent separately patentable subject matter.

The claims are not intended to be limited to the aspects described herein but are to be accorded the full scope consistent with the language of the claims and to encompass all legal equivalents. Notwithstanding, none of the claims are intended to embrace subject matter that fails to satisfy the requirement of 35 U.S.C. § 101, 102, or 103, nor should they be interpreted in such a way.

Embodiments consistent with the present disclosure may be combined with any combination of features or aspects of embodiments described herein.

1. A head mounted display for eye and face tracking, comprising:
an optical assembly arranged proximate to a user's eyes;
a display panel arranged behind the optical assembly and visible to the user through the optical assembly along a line of sight of the user;
a camera arranged so that the user's eyes are visible to the camera through the optical assembly; and
a light source arranged so that light from the light source is incident upon the user's eyes through the optical assembly.

2. The head mounted display of claim 1, wherein the camera is positioned along the line of sight of the user and oriented parallel to the line of sight of the user.

3. The head mounted display of claim 2, wherein the light source is arranged proximate to the camera and is oriented parallel to the line of sight of the user.

4. The head mounted display of claim 1, wherein the camera is a first camera, the light source is arranged proximate to the camera and is a first light source, and the head mounted display further comprises:
a second camera arranged within the display panel so that the user's eyes are visible to the second camera through the optical assembly; and
a second light source arranged proximate to the second camera so that light from the second light source is incident upon the user's eyes through the optical assembly,
wherein the first camera is further positioned off of the line of sight and is oriented at a first angle relative to the line of sight of the user, and
wherein the second camera is further positioned off of the line of sight and oriented at a second angle relative to the line of sight.

5. The head mounted display of claim 4, wherein the first light source is positioned off of the line of sight and is oriented at the first angle relative to the line of sight and the second light source is positioned off of the line of sight and is oriented at the second angle relative to the line of sight.

6. The head mounted display of claim 1, wherein the display panel is one of an LCD display panel, an LED display panel, an OLED display panel, a micro-OLED display panel, and a micro-LED display panel.

7. The head mounted display of claim 1, wherein the display panel is an LCD display panel comprising a thin-film transistor layer attached to a back glass layer, a front glass layer, and a liquid crystal layer arranged between the back glass layer and the front glass layer, and
wherein the camera is arranged within the liquid crystal layer.

8. The head mounted display of claim 7, wherein the light source is arranged within the liquid crystal layer.

9. The head mounted display of claim 1, wherein the camera is positioned along the line of sight and oriented parallel to the line of sight, and the light source is positioned off of the line of sight and is oriented at an angle relative to the line of sight.

10. The head mounted display of claim 1, wherein the display panel is one of a single display panel architecture and a dual display panel architecture.

11. A system for eye and face tracking, comprising:
a processor;
a head mounted display in communication with the processor, the head mounted display comprising:
an optical assembly arranged proximate to a user's eyes;
a display panel arranged behind the optical assembly and visible to the user through the optical assembly along a line of sight of the user;
a camera arranged so that the user's eyes are visible to the camera through the optical assembly; and
a light source so that light from the light source is incident upon the user's eyes through the optical assembly; and
a non-transitory computer readable medium storing a set of instructions, which when executed by the processor, configure the processor to:
display to the user a real-time video on the display panel;
receive a signal from the camera;
process the signal to generate tracking data associated with the user's eyes and face; and
adjust the real-time video based on the tracking data.

12. The system of claim 11, wherein the camera is positioned along the line of sight of the user and oriented parallel to the line of sight of the user, and the light source is arranged proximate to the camera and is oriented parallel to the line of sight of the user.

13. The system of claim 11, wherein the camera is a first camera, the signal is a first signal, the light source is arranged proximate to the camera and is a first light source, and the head mounted display further comprises:
a second camera arranged within the display panel so that the user's eyes are visible to the second camera through the optical assembly; and
a second light source arranged proximate to the second camera so that light from the second light source is incident upon the user's eyes through the optical assembly,
wherein the first camera is further positioned off of the line of sight and is oriented at a first angle relative to the line of sight of the user,
wherein the second camera is further positioned off of the line of sight and oriented at a second angle relative to the line of sight of the user,
wherein the first light source is positioned off of the line of sight and is oriented at the first angle relative to the line of sight of the user,
wherein the second light source is positioned off of the line of sight and is oriented at the second angle relative to the line of sight of the user, and
wherein the instructions, when executed by the processor, further configure the processor to receive a second signal from the second camera, and the tracking data is generated based on the first signal and the second signal.

14. The system of claim 11, wherein the display panel is one of an LCD display panel, an LED display panel, an OLED display panel, a micro-OLED display panel, and a micro-LED display panel.

15. The system of claim 11, wherein the display panel is an LCD display panel comprising a thin-film transistor layer attached to a back glass layer, a front glass layer, and a liquid crystal layer arranged between the back glass layer and the front glass layer,
wherein the camera is arranged within the liquid crystal layer, and
wherein the light source is arranged within the liquid crystal layer.

16. The system of claim 11, wherein the camera is positioned along the line of sight and oriented parallel to the line of sight, and the light source is positioned off of the line of sight and is oriented at an angle relative to the line of sight.

17. The system of claim 11, wherein the tracking data associated with the user's eyes and face comprises at least one of eye movements of the user, gaze direction of the user, and facial expressions of the user.

18. The system of claim 11, wherein the display panel is one of a single display panel architecture and a dual display panel architecture.

19. A method for eye and face tracking, comprising:
displaying to a user a real-time video on a display panel arranged behind an optical assembly, the display panel visible to a user through the optical assembly along a line of sight of the user;
receiving a signal from a camera arranged within the display panel so that the user's eyes are visible to the camera through the optical assembly, the user's eyes illuminated by a light source arranged proximate to the camera so that light from the light source is incident upon the user's eyes through the optical assembly;
processing the signal to generate tracking data associated with the user's eyes and face; and
adjusting the real-time video based on the tracking data.

20. The method of claim 19, wherein the signal is a first signal, the camera is a first camera, and the light source is a first light source, the method further comprising:
receiving a second signal from a second camera arranged within the display panel so that the user's eyes are visible to the second camera through the optical assembly, the user's eyes illuminated by a second light source arranged proximate to the second camera so that light from the second light source is incident upon the user's eyes through the optical assembly,
wherein the tracking data is generated based on the first signal and the second signal.
